(19) United States
(12) Patent Application Publication
(10) Pub. No.: US 2017/0212142 A1
(43) Pub. Date: Jul. 27, 2017

(54) Method And Device For Determining Absolute Speed Of A Rail Vehicle

(71) Applicant: Siemens AG Oesterreich, Wien (AT)

(72) Inventor: Gerard SALZGEBER, Graz (AT)

(21) Appl. No.: 15/327,972

(22) PCT Filed: Jun. 25, 2015
(86) PCT No.: PCT/EP2015/064320

§ 371 Date: Jan. 20, 2017

(30) Foreign Application Priority Data
Jul. 23, 2014 (AT) A 50512/2014

(51) Int. Cl. G01P 3/80; G01P 15/16; G01P 3/50

(52) U.S. Cl. CPC G01P 3/803; G01P 3/50; G01P 15/16

(57) ABSTRACT

A method for determining absolute speed of a rail vehicle including onboard sensor devices and a signal processor, wherein the method includes the steps of detecting irregularities in the rail respectively on one front wheel set via a first sensor device and at least on a subsequent wheel set via another sensor device, and transmitting the sensor signals produced by the sensor devices to a signal processor configured to determine the absolute speed by analyzing the supplied sensor signals, where an estimation of the transfer function between a sensor is used, and where an FIR filter can, in this case, optimally reproduce the signal of one sensor via the signal of the other sensor in which the smallest square of the error is formed such that the time offset between both signals can be determined, from which the speed can be determined at a known distance of the sensor.

### CROSS-REFERENCE TO RELATED APPLICATIONS

This is a U.S. national stage of application No. PCT/EP2015/064320 filed 25 Jun. 2015.

### BACKGROUND OF THE INVENTION

1. Field of the Invention

The invention relates to a device and a method for determining the absolute speed of a rail vehicle, where sensor devices and a signal processing device are provided on board the rail vehicle.

2. Description of the Related Art

In rail vehicles nowadays the speed is normally determined by measuring the wheel rotation rate with a magnet wheel and a magnet wheel sensor, where the sensor signal is fed to a signal processing device, and multiplied at this location by the wheel circumference.

In this conventional method, that the wheel circumference is not a fixed quantity is not taken into account, but changes during the operating life due to wear or profiling. Slippage between the rail and the wheel is also not taken into account, further falsifying the result. Overall, the result of the speed as determined is therefore inaccurate.

### SUMMARY OF THE INVENTION

In view of the foregoing, it is an object of the present invention to provide a device and a method for measuring the absolute speed of a rail vehicle with an improved level of accuracy.

This and other objects and advantages are achieved in accordance with the invention by a method and device based on the consideration that a rail head traveled over by a wheel is not an ideal smooth flat surface, but that during rolling movements each wheel experiences vibration excitation caused by the unevennesses. This excitation is initially experienced by the axle at the front of the rail vehicle in the travel direction and then, delayed by a time interval, the following axle of a wheel truck. In this way, two similar signal patterns arise that differ essentially by a time offset that corresponds to the time difference needed by the wheel disks to pass over a particular point on the rail. When these similar signals are evaluated with a modern processor system, the time offset can be calculated very precisely. In order to place characteristic sequences in similar signals in relation to one another, different methods of signal processing are known. The remainder is a simple calculation because the spacing between the two axles of a wheel truck or between successive wheel trucks in the railroad train is known. Overall, by this means, the absolute speed of the rail vehicle can be easily and accurately calculated.

In order to detect the excitation of the axles of a wheelset or a wheel by measuring technology, different physical variables can be used, for example, displacements, speeds, accelerations or variables derived therefrom, such as their differentials or integrals. Suitable sensor devices are known for detecting these physical variables in a rail vehicle. A sensor device should be understood to be the measuring transducer with the associated signal processing of a sensor signal processed by signal technology. Depending on the arrangement of the measuring transducer, a direction-dependent sensor variable results. In the following, the z-direction is to be understood as the vertical direction relative to the track section, and the y-direction denotes a lateral direction directed laterally to the track section. Due to the equivalent conicity at the wheel-rail contact point, cross-talk of the rail excitation in the z-direction (vertically) to the wheelset movement in the y-direction (laterally) occurs, so that the measuring direction can be in the z-direction and/or the y-direction. The z-direction is more advantageous because it more accurately represents the vertical rail movement, although it can be economically more favorable by joint use of sensors to make use of the y-direction for determining speed. Sensor devices suitable for railroad use are commercially available.

In order to determine the absolute speed of a rail vehicle, the method in accordance with the invention comprises determining unevennesses in the rail, in each case, by a leading wheelset via a first sensor device and at least at a following wheelset via a further sensor device, and transmitting the sensor signals generated by the sensor devices to a signal processing device that is configured to determine, via analysis of the transmitted sensor signals supplied, the absolute speed where, for this purpose, the temporal position of the value maximum in the filter coefficients of the estimated transfer functions between the sensor signals is used for the analysis.

By reason of common use of sensors and/or a simpler assembly and/or a simpler cable routing, it can be favorable if the sensors used are placed on the rail vehicle at different locations. Measuring positions that are fundamentally suitable are those on the axleboxes or directly over a primary spring (paired over the same rail) or directly over a secondary spring of the wheel truck. The acceleration caused by vibrations is preferably detected in the z-direction.

In general, the accelerations are lower the further the sensor equipment is removed from the axlebox position (excitation site) so that, in the closer region, more economical sensors can be used. However, the speed-dependent similarity is less noticeable the further removed the position is from the axlebox position. In order to compensate for this effect, powerful signal processing methods can be used.

It can be advantageous if two sensor devices are used on axleboxes of different wheelsets that lie in pairs over the same rail. The wheelsets being observed can also belong to different wheel trucks. It is of significance only that the spacing between the sensors, seen in the direction of the rail, is known.

It can also be advantageous if the excitation is detected over both rails simultaneously via axlebox sensors.

Herein, the excitations of both the right and the left rail are used to determine the time delay, so that the accuracy and the robustness against faults are enhanced.

It can also be favorable if the sensors are each placed over primary spring stages. With this, design and/or economical advantages can ensue, in particular if sensors are used together with other systems. With regard to distribution of the sensors on the wheel trucks, the same variation options as for the “axlebox” measuring position are possible.

It is also possible to place the sensors on the frame of two or more different wheel trucks. Here, a speed-dependent time difference can also be determined from the excitation signals. Here, spacing “A” to be taken into account is then the spacing between the wheel truck center of one wheel truck from the wheel truck center of the other wheel truck of the wheel trucks considered in respective pairs.

A further improvement is achievable in that for determining the absolute speed, a combination of a plurality of wheel truck pairs is used, so that as a consequence of an averaging effect, the accuracy of the speed measurement can be further improved.

In another preferred embodiment, the sensors are placed in the wagon body above two or more wheel trucks. The advantages of this placement are the simplified cable routing and lower mechanical requirements placed on the sensors, so that the system can be realized more economically. With regard to the distribution of the sensors in the wagon body above the wheel trucks, the same variation options as for the “frame center” measuring position are possible.

One method for determining the time offset can be evaluation via cross-correlation. However, a significant improvement can be achieved with methods of system identification, for example, system identification with the aid of adaptive filters that are very well suited to evaluating the existing excitation signals. With an adaptive filter, the signal of one sensor is estimated with the aid of another sensor signal. In a common excitation of movement sensors, for example, a sensor pair placed over the same rail, the signal of one sensor can be estimated from the signal of the other. In this case, the adaptive filter used for this estimation supplies a transfer function (UTF), which has a clear maximum. The temporal position of the maximum in the transfer function (UTF) then corresponds to the delay Δt between the two signals. From this delay, the speed (sensor spacing in direction of travel divided by the delay Δt) and the direction of travel (sign of the delay) can be determined. Here, calculation of the transfer function can occur both in the frequency domain and also in the time domain. Computer systems suitable for railroad use, for example, special signal processors, microcontrollers and microprocessors are commercially available.

In the context of the invention, the expression “transfer function” (UTF) should be understood to mean a filter function, for example, the filter function of per se known non-recursive filters, of an Finite Impulse Response (FIR) filter that reproduces as well as possible (in the sense of the least error sum) the signal of one sensor via the signal of another sensor. In the analysis of the sensor signals, use is made of the temporal position of the value maximum in the filter coefficients between the sensor signals.

A further improvement can be achieved by determining a common transfer function across a plurality of sensor pairs. This determination can be achieved in that, for example, in a wheel truck with 4 axlebox sensors, a common optimum transfer function (UTF) is calculated in that the following 4 transfer routes are detected: axle 1, right to axle 2, right (forward UTF); axle 2, right to axle 1, right (rearward UTF); axle 1 left to axle 2, left (forward UTF); axle 2, left to axle 1, left (rearward UTF). In the rearward UTF, the temporal sequence is inverted so that the four (4) transfer functions are constructively overlaid. This method can be extended to as many transfer paths as desired, so that both the determination rate and the accuracy are increased. In this way, in a trial of the invention on a locomotive, a reliable speed determination was achieved at a determination rate of 1 s and an accuracy of 0.2 m/s.

It is also an object of the invention to provide a device for determining the absolute speed of a rail vehicle comprising a first sensor device associated with a leading wheelset of the rail vehicle and at least one further sensor device associated with a following wheelset of the rail vehicle, where each of these sensor devices is configured to detect unevennesses of the rail, a signal processor to which the signals of the individual sensor devices are sent, where the signal processor is configured to perform analysis of the sensor signals and to determine the absolute speed from the sensor signals where the temporal position of the value maximum in the filter coefficients of the estimated transfer functions between the sensor signals is used for the analysis.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

For further explanation of the invention, reference will be made in the following section of the description to the drawings which illustrate further advantageous embodiments, details and developments of the invention, using non-limiting exemplary embodiments, in which.

FIG. 1 is a schematic representation of a wheel truck with a leading and following wheelset, seen from the side, where in the exemplary embodiment shown, the sensor devices are arranged on the axleboxes in accordance with the invention;

FIG. 2 is a graphical plot of a first excitation signal as a function of time, measured at the leading wheelset of FIG. 1;

FIG. 3 is a graphical plot of a second excitation signal as a function of time, measured at the following wheelset of FIG. 1;

FIG. 4 is an exemplary embodiment of the invention, where the sensor device is arranged on the wheel truck frame on a wheel truck above the primary springs of the axleboxes of the wheelsets;

FIG. 5 is a further exemplary embodiment of the invention, where the measuring position is placed in the wagon body, in each case, above the wheel truck center, and where a plurality of such measuring devices are taken into account for the determination of the absolute speed; and

FIG. 6 is a flowchart of the method in accordance with the invention.

### DETAILED DESCRIPTION OF THE EXEMPLARY EMBODIMENTS

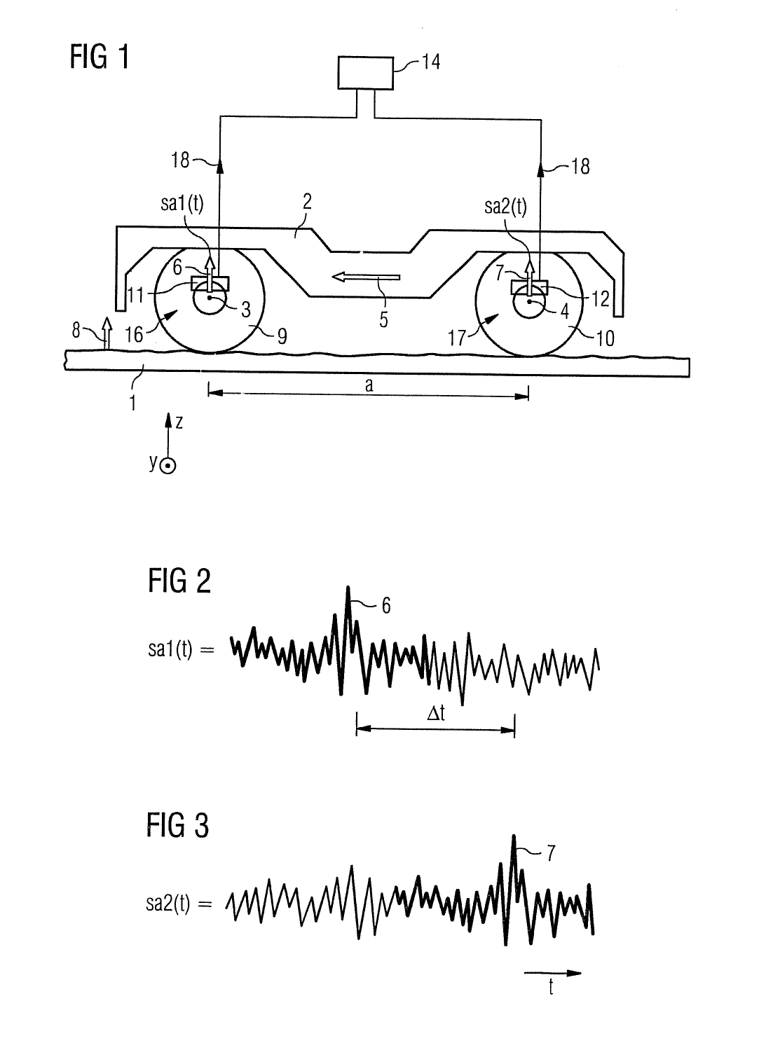

FIG. 1 shows, in a simplified representation, a wheel truck 2 of a rail vehicle (not shown in detail). Wheels 9, 10 are arranged in pairs on a wheelset 16 positioned in front in the direction of travel and on a following wheelset 17. The wheelsets have an axle spacing “a” from one another. As shown in exaggerated form in FIG. 1, the running surface of the rail 1 is uneven. In the view shown in FIG. 1, the direction of travel is from right to left. If, therefore, the front wheel 9 travels over an unevenness, the following wheel follows it in a temporally offset manner. The unevennesses causes vibration excitations that are evaluated by measuring technology. As FIG. 1 indicates, a sensor device is associated with each axlebox: the sensor device 11 with the front axle, the sensor device 12 with the rear axle. These sensor devices 11, 12 can represent different physical parameters according to embodiment, depending on direction, for example: displacement, speed, acceleration or variables derived therefrom, such as their differential or integral. In relation to the track section, the z-direction should be understood as a vertical direction, whilst the y-direction denotes a lateral direction. Each sensor device generates a respective sensor signal 18 that is supplied to a signal processor and evaluation device 14. The evaluation device essentially consists of a processor system suitable for railroad use. An algorithm able to run on this processor system determines the similarity of the two temporally sequential sensor signals 18. In the present example, this is an algorithm for calculating the transfer function (UTF) via an adaptive filter, where the calculation can occur both in the time domain and also in the frequency domain. An FIR filter reproduces the signal of one sensor as well as possible via the signal of another sensor in that the least error sum is formed. The comparison result is the temporal delay Δt being sought (see FIGS. 2 and 3).

FIGS. 2 and 3 show, by way of example, graphical plots of the measurement signals arising from unevennesses of the rail as a function of time: the excitation signal 6 at the front wheel 3 (signal pattern “sa1(t)” in FIG. 2) and the excitation signal 7 at the rear wheel 4 (signal pattern “sa1(t)” in FIG. 3). Both signals 6, 7 are similar in their temporal sequence, essentially displaced by a time interval Δt. If this temporal delay Δt is known after the evaluation of the similarity, then taking the known spacing “a” between the axles 3, 4 of the wheels 9, 10, the actual speed of the rail vehicle can very easily be determined by evaluating the relation v=a/Δt (where v is absolute speed; a is axle spacing; Δt is the delay).

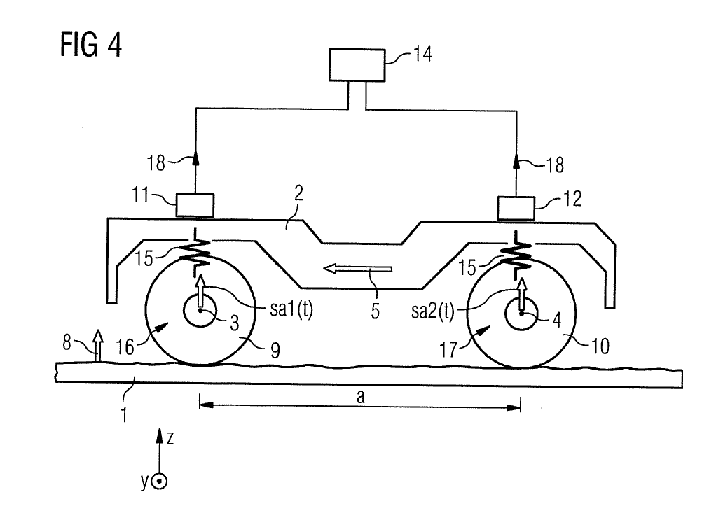

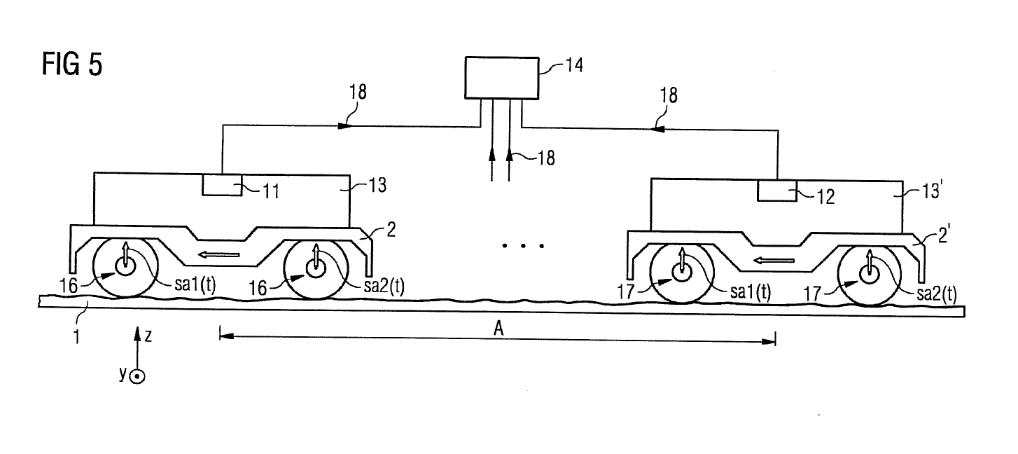

FIG. 4 shows an embodiment of the invention in which, on a wheel truck 2, the sensors 11, 12 are placed over the primary spring stage 15. The principle is as described above. The excitation signals (in FIGS. 2 and 3, the signal patterns “sa1(t)” and “sa2(t)”) determined by the two sensors 11, 12 are each fed as a signal 18 to the signal detecting and evaluating device 14, which then determines the delay Δt and calculates the actual speed of the rail vehicle using the relation given above.

FIG. 5 shows another exemplary embodiment of the invention. Here, the two sensor devices 11 and 12 are each arranged in a wagon body 13, where each of these wagon bodies 13 is situated on a front wheel truck 2 and a rear wheel truck 2′. Further wheel trucks can be arranged in the railroad train between these two wheel trucks 2, 2′. Each of the signals 18 generated by the measuring devices 11 and 12 is passed on to a signal capture and evaluating unit 14. This unit determines the delay Δt between the signals 6, 7 using the aforementioned algorithm for signal analysis. As distinct from the representation in FIGS. 1 and 4, in the present example, the spacing “A” between the two wheel trucks 2, 2′ is used for the determination of the absolute speed v.

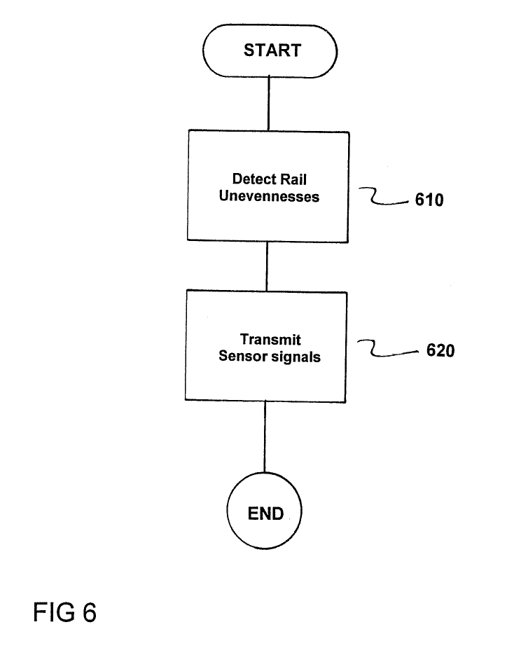

FIG. 6 is a flowchart of a method for determining an absolute speed of a rail vehicle, where sensor devices (11, 12) and a signal processing device (14) being provided on board the rail vehicle. The method comprises detecting an unevennesses of a rail (1) at a leading wheelset (16) of the rail vehicle via a first sensor device (11) and at least at a following wheelset via a further sensor device (12), as indicated in step 610. Sensor signals (18) generated by the first and further sensor devices (11, 12) are now transmitted to a signal processor (14) which is configured to determine, via analysis of the transmitted sensor signals (18) supplied to the signal processor (14), an absolute speed, as indicated in step 620. In accordance with the invention, the temporal position of a value maximum in the filter coefficients of an estimated transfer functions (UTF) between the transmitted sensor signals is used during the analysis.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. A method for determining an absolute speed of a rail vehicle, sensor devices and a signal processing device being provided on board, the method comprising:
a) detecting an unevennesses of a rail at a leading wheelset of the rail vehicle via a first sensor device and at least at a following wheelset via a further sensor device; and
b) transmitting sensor signals generated by the first and further sensor devices to a signal processor which is configured to determine, via analysis of the transmitted sensor signals supplied to the signal processor, an absolute speed, a temporal position of a value maximum in filter coefficients of an estimated transfer functions between the transmitted sensor signals being utilized during said analysis.

18. The method as claimed in claim 17, wherein the first and further sensor devices are configured to detect one of (i) a displacement, (ii) a speed, (iii) an acceleration in a z (vertical) direction (iv) a y (lateral) direction and (v) a respective differential or integral of the first and further sensor devices.

19. The method as claimed in claim 17, wherein at least two sensor devices are respectively arranged on successive axleboxes of different wheelsets.

20. The method as claimed in claim 18, wherein at least two sensor devices are respectively arranged on successive axleboxes of different wheelsets.

21. The method as claimed in claim 17, wherein a sensor device is configured to detect unevennesses of one of (i) one and another rail and (ii) over both rails simultaneously via axlebox sensors.

22. The method as claimed in claim 18, wherein a sensor device is configured to detect unevennesses of one of (i) one and another rail and (ii) over both rails simultaneously via axlebox sensors.

23. The method as claimed in claim 18, wherein the first and further sensor devices are each arranged over an associated primary spring.

24. The method as claimed in claim 18, wherein the first and further sensor devices are arranged on a plurality of wheel trucks traveling one behind another; and wherein sensor signals of leading wheelsets and following wheelsets are utilized to determine the absolute speed of the rail vehicle.

25. The method as claimed in claim 17, wherein the first and further sensor devices are arranged on a plurality of wheel trucks of a rail vehicle; and wherein a combination of a plurality of wheel truck pairs is utilized to determine the absolute speed of the rail vehicle.

26. The method as claimed in claim 17, wherein the signal processing device is a digital computer system which calculates the transfer functions via adaptive filters from the transmitted sensor signals supplied sensor signals and which, from a temporal position of a maximum in a shape of the filter coefficients, determines the absolute speed.

27. The method as claimed in claim 26, wherein the signal processing device takes into account sensor signals of a plurality of sensor pairs during determination of the transfer functions.

28. A device for determining the absolute speed of a rail vehicle, comprising:
a) a first sensor device associated with a leading wheelset of the rail vehicle;
b) at least one further sensor device with a following wheelset of the rail vehicle, the first and further sensors being configured to detect unevennesses of a rail;
c) a signal processor to which sensor signals of individual sensor devices are supplied, the signal processor being configured to perform an analysis of the sensor signals and to determine the absolute speed of the rail vehicle from the supplied sensor signals;
wherein a temporal position of a value maximum in filter coefficients of the estimated transfer functions between the sensor signals is utilized during the analysis.

29. The device as claimed in claim 28, wherein the first and further sensor devices are configured to detect one of (i) a displacement, (ii) a speed, (iii) an acceleration in a z (vertical) direction (iv) a y (lateral) direction and (v) a respective differential or integral of the first and further sensor devices.

30. The device as claimed in claim 28, wherein the first and further sensor devices are each formed by axlebox sensors which are arranged on different wheelsets.

31. The device as claimed in claim 28, wherein at least two sensor devices are respectively arranged on successive axleboxes of different wheelset.

32. The device as claimed in claim 28, wherein the rail vehicle comprises a plurality of wheel trucks, the first and further sensor devices being arranged on a plurality of said wheel trucks and each sensor signal being supplied to the signal processing device.

33. The device as claimed in claim 28, wherein the signal processing device is a digital computer system which calculates, via adaptive filters, from the supplied sensor signals, the transfer functions and determines the absolute speed of the rail vehicle from the transfer functions.

34. The device as claimed in claim 33, wherein the signal processing device take into account sensor signals of a plurality of sensor pairs to determine the transfer functions.
